(19) United States
(12) Patent Application Publication
(10) Pub. No.: US 2009/0211354 A1
(43) Pub. Date: Aug. 27, 2009

(54) Materials Testing

(75) Inventors: Paul L.M.G.D. Lambert, Cleveland (GB); Robin S. Bailey, Northallerton (GB); Alan McNicol, North Yorkshire (GB); John Carroll, Stockton-on-Tees (GB)

Correspondence Address: JONES DAY, 222 EAST 41ST ST, NEW YORK, NY, 10017, US

(73) Assignee: Imperial Chemical Industries PLC, London (GB)

(21) Appl. No.: 11/991,731

(22) PCT Filed: Aug. 24, 2006
(86) PCT No.: PCT/GB2006/003151

§ 371 Date: Mar. 9, 2009

(30) Foreign Application Priority Data
Sep. 9, 2005 (GB) 0518423.9

(51) Int. Cl. G01N 19/04

(52) U.S. Cl. 73/150 A

(57) ABSTRACT

Methods of and apparatus for testing a material are described. The testing involves providing a material across a region of a support member which is arranged to define an opening which is closed by a plug means having a surface in contact with the material that is substantially coplanar with the region. The material is adhered to the region of the support member. A force applying means is moved relative to the material to apply a force to said material through the intermediary of the plug means, which does not substantially deform under the application of the force.

This invention relates to materials testing and particularly, although not exclusively, provides a method of testing a material and apparatus therefor.

There are numerous known methods of testing materials either as one-off samples or with a multiplicity of materials to be tested in an array. Examples of methods and apparatus for testing materials are described in U.S. Pat. No. 2,723,554, U.S. Pat. No. 4,567,774, US-A-2003/0037620, US-A-2003/0054740 and EP-A-158290. Disadvantageously, many known methods simply provide “pass/fail” results rather than any significant quantitative data. Additionally, in some cases, very expensive and complex apparatus is used.

WO 2004/109258 (which is incorporated herein in its entirety by reference) describes methods and apparatus for testing materials which, although can be used in a “pass/fail” mode, may also generate significant data relating to the test materials. In WO 2004/109258, a probe is passed into and/or through an opening across which material to be tested is located. In one embodiment of WO 2004/109258, the opening is initially closed by a plug of, for example, a low friction particulate material such as lightly-sintered PTFE whereby the test material is prevented from sagging into the opening either during its in situ formation from precursor material or whilst it is retained, for example by adhesion or other means, relative to the opening. The plug disintegrates under very small loads when the probe contacts it, either directly or indirectly, and negligibly affects the force measurements.

Whilst this particular embodiment of WO 2004/109258 has utility in a number of test scenarios, when it is used to perform blister tests, the probe is prone to penetrate the test material rather than to push the test material away from the surface of the support member, which defines the opening through which the probe passes, and initiate delamination fractures either between the support member and the test material or within the test material, ie cohesive failure of the test material. Such blister tests have in the past been performed using fluid pressure to cause delamination of the test materials.

It is an object of the present invention to at least reduce or to obviate the problem outlined in the preceding paragraph.

According to a first aspect of the invention, there is provided a method of testing a material, the method comprising providing a material to be tested (hereinafter “test material”) across a region of a support member which is arranged to define an opening, said opening being substantially closed by a plug means having a surface in contact with said test material that is substantially coplanar with said region, said test material being adhered to said region of the support member, and moving a force applying means relative to said test material to apply a force to said material through the plug means in a direction away from said region of the support member and wherein the plug means does not substantially deform under the application of said force.

Said method preferably includes recording the force applied to said test material or a parameter relating to the force applied by said force applying means. The method may simply comprise assessing whether said test material passes or fails a test in which case only a single value for force applied may be recorded. The force may be measured to an accuracy of at least 5 mN, preferably at least 2 mN, more preferably at least 1 mN. Suitably, however, a multiplicity, preferably at least 10, more preferably at least 100, typically 500-1000, values for the force applied to said test material are recorded at different times during the testing of said material. Preferably, data relating to the force applied is recorded in a database, suitably under the control of a computer. Preferably, said computer controls the movement of said force applying means relative to said test material.

Preferably, the method involves said force applying means applying a force that deforms the test material. Preferably, data relating to the deformation of the test material is recorded in said database. Preferably, said data is related to the distance traveled by the force applying means relative to the test material. The distance traveled may be measured to an accuracy of at least 10 μm, preferably to at least 5 μm, more preferably to at least 2 μm. Preferably, a multiplicity, more preferably at least 10, values for the distance traveled is recorded at different times during the testing of said material. Preferably, values for the force applied and distance traveled are taken substantially concurrently during the method.

Preferably, the method involves constructing a force versus displacement relationship in the form of a graph, for the test material. This will enable the energy involved in the deformation process to be determined.

Movement of the force applying means relative to the test material preferably involves movement in the direction of a z axis that is perpendicular to an x-y plane in which the test material is generally arranged. Preferably, movement of the force applying means relative to the test materials involves vertical movement. Preferably, the method involves moving the force applying means to apply said force to said material. Said force applying means preferably moves downwardly. Preferably, said test material is stationary (except for any movement, e.g. deformation, caused by said force applying means) during application of said force. Preferably, said force applying means moves in the direction of a z axis as described (e.g. vertically) during application of said force and preferably, is only moved vertically during application of said force (i.e. there is substantially no movement of said force applying means in an x-y plane which is perpendicular to said z axis (e.g. no horizontal movement) during application of said force)).

The method may involve moving the test material to a position in which said force applying means may apply said force. Said test material is preferably moved in the x-y direction, suitably in a substantially horizontal plane. Said test material is suitably moved in the method so that the force applying means is directly above the region of the support member which is arranged to define said opening. Preferably, a z axis (e.g. a vertical axis) of said force applying means (which axis defines the direction in which the force applying means moves relative to the test material) is substantially in line with the centre of the region which is arranged to define said opening so that when said force applying means passes through the opening it passes substantially centrally through the opening. Movement of the test material to said position described is preferably under the control of a computer. The positioning of the test material in the desired position is described in more detail hereinafter.

Preferably, said force applying means comprises a probe (which is preferably elongate and has its axis of elongation extending in the z direction (e.g. vertically) in which it is arranged to move) which moves (preferably in said z direction, e.g. substantially vertically) in the method and indirectly contacts said test material through the plug means to apply said force thereto. Thus, the force applying means enters the opening to apply said force to the test material through the intermediary of the plug means.

Preferably, the probe and the plug means are separate from one another, thus enabling the probe to be used in serial testing of multiple samples, if required. Alternatively, the probe and the plug means may be integral, it being necessary to clean the surface of the plug adhered to the test material prior to testing another material.

Preferably, although not necessarily, the support member and the plug means are made of the same material. The actual material selected for the support member and the plug means may depend upon the test material, ie a prerequisite is that the test material will adhere to the support member. The test material may also adhere to the plug means. A preferred material for the support member and the plug means is copper.

Depending upon the adherent properties of the test material, it may be necessary to either polish the surface of the support member, and the plug means, to a mirror finish or, alternatively, provide a roughened surface to generate a higher surface area to which adhesion may occur. The surfaces to which the test material adheres may also be subjected to suitable cleaning regimes using appropriate organic solvents and demineralised water or other pre-treatments as is well understood in the art to achieve good adhesion.

To prevent seepage of the test material (described in more detail below) between the support member and the plug means into the opening defined by the support means during adherence of the test material to the support member and the plug means, the plug means is preferably a close fit in the opening. However, it will be appreciated that too close a fit in the opening will result in high frictional forces being generated between the plug means and the opening, thus affecting the test results. Preferably, the tolerance between the plug means and the opening is of the order of 25 μm to 50 μm, more especially about 37 μm.

Alternatively, the close fit between the opening and the plug member is achieved by using a plug means comprising a central member defining the surface to which the test material adheres and an annular member of low friction material, for example silicon rubber, surrounding the central member and having an end surface coplanar with the surface of the central member to which the test material adheres. The annular member may extend the whole length of the central member; or, alternatively, it may extend only a part of the length of the annular member. In the latter case, the annular member may be retained in position by an annular shoulder formed on the central member.

The size of the opening and area of the surface of the plug means that is contacted by the test material may vary within limits. For example, if the test material has high cohesive strength and low adhesive strength, the surface area of the plug means may be relatively small; but not so small as to promote puncture of the test material by the plug means. Conversely, if the test material has a low cohesive strength and a high adhesive strength, then the surface area of the plug means would need to be increased to minimise puncturing of the test material by the plug means.

Said support member preferably defines a receptacle for containing the test material and a region which is arranged to define said opening. Said opening may be positioned centrally within the receptacle, preferably in a lower wall of the receptacle. More than one opening may be positioned within the receptacle, each being sufficiently remote from the periphery of the receptacle and from each other to ensure measurements are not affected by edge effects.

The receptacle is preferably shaped such that the test material forms a substantially cylindrical shape. Alternatively, the receptacle may be shaped such that the test material forms a substantially frustoconical shape, the smaller diameter plane surface thereof being adhered to the surface of the plug means during the test of the test material.

In a first embodiment, said test material may be preformed, for example it may comprise a film, and the method may include the step of selecting said preformed test material and positioning it across said region of said support member. Preferably, the test material is clamped in position, suitably between two clamp plates, one of which incorporates said support member. The method in this embodiment includes the step of adhering the test material to said region of the support member and, if required, to the surface of the plug means. The adherence of the test material may be achieved using an interposed adhesive layer; or, alternatively, the inherent adhesive qualities of the test material. In either instance, the adhesion of the test material to said region of the support member and to the surface of the plug means may be achieved under ambient conditions or, more preferably, using heat and/or pressure.

A plurality of different test materials, for example films, may be clamped between clamp plates in which a plurality of openings may be arranged. The force applying means may then be moved to address each test material associated with an opening, in order to apply a force to the test material. The method described may be useful for test materials that are reasonably robust so that they can be handled with little detriment.

In a second embodiment, the method may involve forming the test material in situ. In this case, a precursor of the test material may be selected and contacted with said support member; said test material, which is suitably in a different physical form compared to said precursor, may then be formed. For example, said test material may be a film that is formed from a precursor that is suitably a flowable material and may be a liquid, a viscous fluid, a gel (or the like), a suspension or a free flowing solid material. Said precursor may be dispensed by any suitable means. For example, it could be dispensed using ink jet printer technology or by sputtering. Said precursor may be cast on said support member and a solvent removed thereby to form the film. The precursor may include at least first and second components that are involved in the formation of the test material. In a series of tests, the identity, and/or amounts of the first and second components may be varied; and/or the processes to which the first and second components may be subjected may be varied; and/or the identity and/or amounts of other components may be varied with a view to affecting the properties of the test material formed. Advantageously, formation of test materials in situ eliminates the need to handle (and risk damaging) test materials and the method can be used to test brittle material that could not be tested by other methods.

The second embodiment described represents another preferred aspect of the invention. Thus, the invention extends to a method of testing a test material, the method comprising providing a selecting a precursor of said test material, contacting said precursor with a support member and forming said test material on the support member across a region of a support member which is arranged to define an opening, said opening being substantially closed by a plug means having a surface in contact with said test material that is substantially coplanar with said region, said test material being adhered to said region of the support member, moving a force applying means relative to said test material to apply a force to said material through the plug means in a direction away from said region of the support member and wherein the plug means does not substantially deform under the application of said force and recording the force applied or a parameter relating to the force applied to said test material by said force applying means.

The force applying means passes into the opening before contacting the test material through the intermediary of the plug means.

The test material may also be adhered to said surface of the plug means.

Although the embodiments and aspects of the invention described above are a significant improvement on the prior art method with respect to reducing or obviating puncturing of the test material by the force applying means and/or any plug means interposed therebetween, depending upon the materials under test, it is still possible for puncturing of the test material to remain a significant problem. In this instance, the receptacle formed by the support member, as described above, is preferably shaped such that the test material has significant depth, and, preferably, forms a substantially cylindrical shape, and wherein the method according to the invention includes forming the test material such that it has a maximum transverse dimension, eg diameter, to thickness ratio of at least 1:0.5, more preferably of at least 1:0.75 and more especially is about 1:1.

During the method of the invention, to achieve adhesion testing, the force applying means is moved relatively slowly, towards the stationary test material. The force applying means slowly deforms and/or causes delamination of the test material and the method involves measuring the force applied and distance traveled by the force applying means. The energy per unit area (ie the energy to delaminate a unit area of adhesive) may be determined which is a measure of adhesive strength. Alternatively, rather than determining absolute values, the method may be used to rank a series of test materials.

In one form of the invention, said method involves testing a plurality of test materials. In this case, the method comprises providing a plurality of test materials across respective regions of said support member which are arranged to define respective openings, each said opening being substantially closed by a respective plug means having a surface in contact with said respective test material that is substantially coplanar with its respective region, said test materials being adhered to their respective regions of the support member and to said surfaces of the respective plug means, and moving a force applying means relative to said test materials to apply a force to said materials through the respective plug means in a direction away from its respective region of the support member and wherein the plug means do not substantially deform under the application of said force.

Preferably, said regions of said support member are substantially identical to one another. Preferably, in the method, said force applying means applies a force to each of said plurality of test materials in substantially the same manner.

Said support member may include at least 6, preferably at least 10, more preferably at least 15 regions across which test materials are arranged. Said support member preferably defines an array of said regions which regions are preferably arranged in parallel rows. Said support member may be in the form of a well plate in which said regions are defined.

Alternatively, if the history of the test materials, eg specific chemical treatment, thermal treatment, measurement at temperature before degradation occurs, etc, is critical to the data being collected, then it is preferable that the test materials are prepared and tested in series in individual sample holders.

Preferably, the method includes the step of the same force applying means applying a respective said force to each of said plurality of test materials in turn. Thus, the method preferably includes said force applying means applying a force to a first material of said plurality of test materials; and then said force applying means moves relative to said test materials so that it can apply a force to a second material of said plurality of test materials. Although the force applying means itself could move between said first and second materials, the method preferably includes the step of moving said support member to enable said force applying means to apply said force to first and second materials as described. Suitably, said support member is arranged to move (in the direction of an x-y plane (e.g. substantially horizontally) in the method in order to allow the force applying means to apply said force (suitably in a z direction perpendicular to the x-y plane, e.g. vertically) to said plurality of test materials. Preferably, in the method, the force applying means is not moved in said x-y plane (e.g. horizontally) between the application of respective forces to said first and second materials.

Preferably, the method involves recording data relating to each test material in a database.

Preferably, a computer controls the movement of said force applying means relative to each test material. Preferably, the computer is programmed to accurately position the force applying means so that it may apply a force to a test material and pass centrally towards, into and/or through the opening. The method suitably involves the use of a positioning method to achieve this.

The positioning method may involve real-time centring with accurate detection of the opening, for example using a camera and/or a technique using electromagnetic waves. Such a technique is described in detail in the aforementioned WO 2004/109258 to which reference should be made.

According to a second aspect of the invention, there is provided apparatus for testing a material (hereinafter “test material”), the apparatus comprising a support member which has at least one region that is arranged to define an opening and across which a test material may be located in use; said opening being substantially closed, in an initial set up of said apparatus, by a plug means having a surface contactable in use with said test material that is substantially coplanar with said region, said region of the plug means being capable of being adhered to by a test material, and a force applying means which is movable relative to the support member for applying a force through the plug means to a test material located in said region during use.

Said apparatus is preferably for carrying out the method described above and may have any feature described above utilized in carrying out said method.

Said support member is preferably movable in the x-y direction suitably in a horizontal plane, for positioning the opening(s) relative to the force applying means. Said force applying means may be movable in the z direction, perpendicular to an x-y plane (e.g. preferably substantially vertically), to apply said force.

Said apparatus preferably includes a computer. Said computer preferably includes an output for controlling movement of the force applying means relative to the support member; and an input for receiving data relating to the force applied and the reaction of the test material to the force applied. Said computer preferably controls the movement of the support member and said force applying means. A database of parameters is preferably associated with said computer. Said database preferably includes coordinates for each opening associated with said support member. Said computer is preferably arranged to control movement of the support member according to said coordinates stored in said database to enable said force applying means to apply a force to a test material.

Said apparatus preferably includes first measurement means for measuring the force applied by said force applying means and preferably includes second measurement means for measuring the distance traveled by said force applying means during a test. Said first and second measurement means are preferably arranged to communicate with said computer and/or database so that measurements taken can be stored.

Said database preferably includes means for storing information relating to the identity of each test material tested using the apparatus. The information stored may include details on the chemical identity of the test materials and/or processes used in their preparation.

In one embodiment, said support member comprises a well plate which includes an array of receptacles each of which includes a respective said opening into and/or through which said force applying means is arranged to pass in use. The apparatus is preferably arranged to test materials positioned in each receptacle.

Alternatively, said support member comprises an individual sample holder.

Any feature of any aspect of any invention or embodiment described herein may be combined with any feature of any aspect of any other Invention or embodiment described herein mutatis mutandis.

Specific embodiments of the invention will now be described, by way of example, with reference to the accompanying diagrammatic drawings, in which:

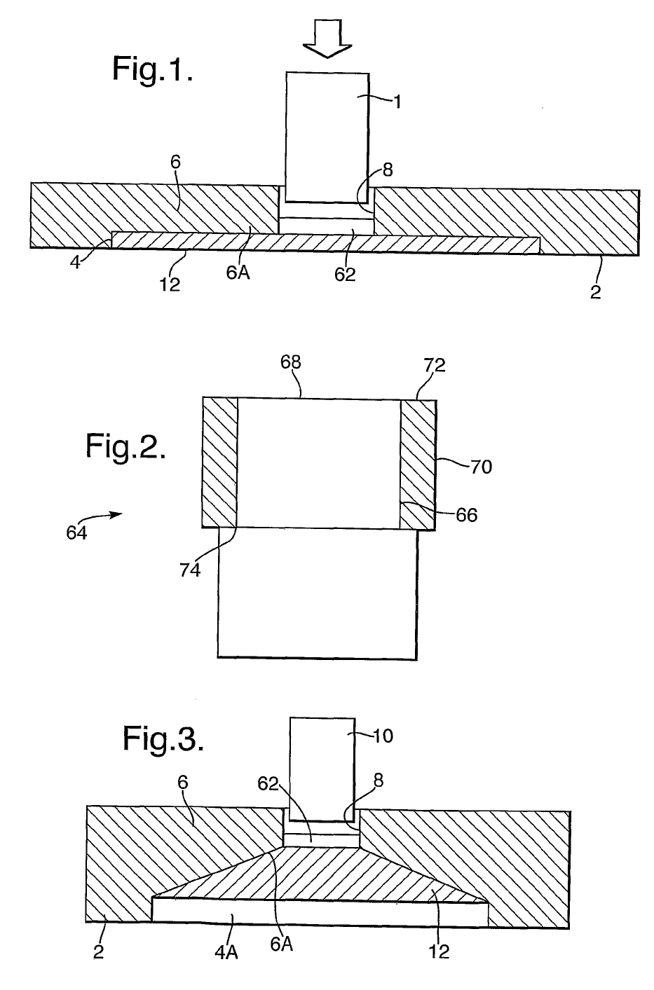

FIG. 1 is a schematic section of part of a well plate showing a sample about to be tested;

FIG. 2 is a schematic representation, partly in section, of a plug;

FIG. 3 a schematic section of part of a well plate having a modified well showing a sample about to be tested;

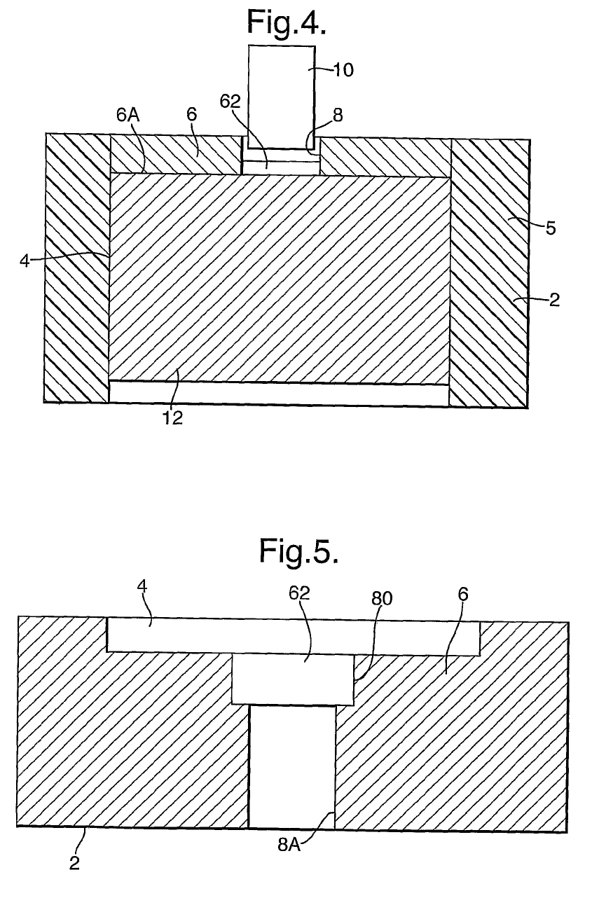

FIG. 4 is a schematic a schematic section of part of a well plate having a modified well showing a sample about to be tested; and

FIG. 5 is a schematic section of part of a well plate showing retention means for a plug.

In the Figures, the same or similar parts are annotated with the same reference numerals.

The method and apparatus of the invention is similar and, in many aspects, the same as the methods and apparatus described in WO 2004/109258 and reference is made to that document for a general description of such methods and apparatus. In particular, reference is made to FIGS. 4 and 5 of WO 2004/109258 and the accompanying description relating to a well plate 2 having an array of wells 4 for testing multiple samples of test materials and the location of the indentor 10 relative to the axes of the channels 8 defined in the wells 4.

As discussed previously, WO 2004/109258 also describes an embodiment (see FIGS. 9(a) to (d) thereof) in which the opening, ie the channel 8, which is defined by the base of the well 4 is initially closed by a plug 58 of, for example, a low friction particulate material such as lightly-sintered PTFE whereby the test material is prevented from sagging into the opening either during its in situ formation from precursor material or whilst it is retained, for example by adhesion or other means, relative to the opening. The plug 58 disintegrates under very small loads when the probe, ie the indentor 10, contacts it, either directly or indirectly, and negligibly affects the force measurements.

Referring now to FIG. 1 of this application, apparatus according to the invention for testing a film of test material comprises an individual sample holder 2 in which a cylindrical well 4 is defined. The well 4 has a base wall 6 which includes a circular cross-section channel 8. Accommodated within the channel 8 is a circular cross-section plug 62 which is a close fit therein and has an end surface substantially coplanar with the end surface 6A of the base wall 6 of the well 4. In use, a film 12 to be tested is adhered to the end surface 6A of the base wall 6 of the well 4 and, if required, to the end surface of the plug 62 that is coplanar therewith.

A wide range of materials may be tested using this apparatus. The film samples may be prepared in a combinatorial technique and data relating to the preparation stored in a database so that each film can be identified.

In one embodiment, preformed film samples 12 of test materials are introduced into the wells 4 of individual holders 2, the plugs 62 being supported with their upper surfaces substantially coplanar with the end surfaces 6A of the base walls 6 of the wells 4. If the test materials inherently have adhesive properties, the holders 2 and the samples 12 are subjected to appropriate conditions, for example heat and/or pressure, to adhere the film samples 12 to the respective end surfaces 6A of the base walls 6 and plugs 62. Alternatively, adhesive layers may first be introduced to the surface of the film samples 12 that are to be in adhesive contact with the base walls 6 and, if required, plugs 62 and/or introduced to the base walls 6 and, if required, the plugs 62. The holders 2 and samples 12 are then, if necessary, subjected to appropriate conditions to adhere the film samples 12 to the end surfaces 6A of the base walls 6 and, if required, to the plugs 62.

In another, preferred, embodiment, precursors of the test materials may be introduced into the wells 4 of the individual holders 2 and under appropriate conditions, for example heat and/or pressure, form the film samples 12 adhered to the end surfaces 6A of the base walls 6 and, if required, to the plugs 62. In this instance, a predetermined amount of precursors may be introduced into the well 4 in the holder 2 and, optionally, the holder 2 may be oscillated gently to facilitate consistent film formation.

Once the film sample 12 is in place or formed in the well 4, the holder 2 is inverted (to the orientation shown in FIG. 1 hereof) and an indentor 10 is moved downwardly to contact the plug 62 associated with the well 4 thereby to apply a force to the film sample 12 to cause it to pull away from the end surface 6A of the base wall 6 and/or cohesively fail. During the test, the force applied and the distance traveled by the indentor are monitored and data is recorded in a database. From the recorded data, characteristics of the adhesive may be determined. The holder is then removed and a second holder is presented to the indentor 10 to subject the film sample 12 in its well 4 to the test regime. In contrast to the method described in WO 2004/109258, the plugs 62 of the apparatus according to the invention do not substantially deform under the application of the force by the indentor 10.

If required, the samples 12 may be subjected to pre-treatments prior to testing. For example, the sample holder 2 with its film sample 12 in position in the well 4 may be raised to an elevated temperature, for example 260° C. or more at which temperature the test is then performed to determine the material performance under performance conditions or under extreme conditions.

The indentor 10 is controlled by a universal testing machine, for example an Instron MicroTester as described in WO 2004/109258. The positioning of the indentor 10 relative to the axes of the channels 8 may be achieved using one of the techniques described in WO 2004/109258, for example mapping the plate to achieve accurate positioning of the x-y stage.

After the or each film sample 12 has been tested, the database stores all relevant information on the or each film, for example, relating to the process for its preparation; the materials used in its preparation; the force applied and the distance traveled by the indentor 10, which enables physical properties of the film samples to be determined.

The materials from which the sample holders 2, or at least the wells 4, and the plugs 62 are made of will depend upon the materials under test to ensure good adhesion occurs between the end surfaces 6A of the well bases 6 and, if required, the plugs 62 and the film samples 12. Although the materials from which the wells 4 and the plugs 62 are made need not be the same, preferably they are the same.

In a particular embodiment, conductive adhesives used in the electronics industry for example may be tested. An example of such an adhesive is a silver-filled bismaleimide formulation. In this instance, the wells 4 and the plugs 62 are preferably made of copper. To ensure good, repeatable results the well bases and the upper surfaces of the plugs 62 are polished to a mirror finish and are subject to a chemical pre-treatment to degrease and clean the surfaces.

To prevent seepage of the test material under the conditions used to promote adhesion, especially when using liquid precursor materials, the plugs 62 are a close fit within the channels 8; in particular they are manufactured to a tolerance of between 25 μm and 50 μm.

In an alternative embodiment to achieve a close fit between the plug and the channel 8, an alternative construction of plug may be used. As shown in FIG. 2 of this application, the plug 64 may comprise a central member 66 defining the surface 68 to which the test material adheres and an annular member 70 of low friction material, for example silicon rubber, surrounding the central member 66 and having an end surface 72 coplanar with the surface 68 of the central member 66. The annular member 70 may extend the whole length of the central member 66 (not shown); or, preferably alternatively, it may extend only a part of the length of the annular member 70 and be retained in position by an annular shoulder 74 formed on the central member 66.

An alternative well configuration is shown in FIG. 3 of this application. In this embodiment, the well 4A is substantially frustoconical in shape. The end surface 6A of the base wall 6 is at an angle of about 30° to the horizontal and tapers inwardly toward the channel 8 such that it forms a substantially continuous surface with the upper surface of the plug 62. In the context of this configuration, the end surface 6A of the base wall 6 is considered to be substantially coplanar with the upper surface of the plug 62.

In preferred embodiments, the thickness of the test material in samples that are substantially uniform in thickness is at least 2.5 mm and, more especially, at least 3 mm. Investigation showed that at or above such thicknesses the stiffness of the material under test conditions became substantially Independent of the thickness of the samples. Typically, the film samples have a diameter of 10 mm, the plug having a diameter of 3 mm and a depth of 2 mm. If too small a diameter of plug, eg 1 mm is selected, the shear affect on the samples increases significantly. Increasing the plug diameter, for example up to 5 mm, has little effect on the shear affect experienced by the samples.

With some materials, it may be preferable to go to even greater thicknesses to minimise the possibility of sample puncture as opposed to well/sample delamination or sample cohesive failure. For example, as shown in FIG. 4 of this application, the ratio of the diameter to the thickness of the sample 12 is of the order 1:0.6.

FIG. 4 also shows an alternative preferred embodiment in which the well 4 is formed temporarily during sample formation. In this embodiment, the side wall 5 of the sample holder 2 is formed by a PTFE sleeve that is a tight or an interference fit over the base wall 6 of the holder 2. Once the sample 12 is in position in the well and prepared for testing, eg has been cured, the sleeve 5 is cut away and removed. The sample is then tested.

The plug 62 may be retained in the channel 8 during formation and/or adhesion of the film sample to it and to the well base 6 by any suitable means. For example, an insert may be located in the channel with a support end, on which the plug 62 is located, spaced inwardly from the well base 6 by a distance equal to the thickness of the plug 62. The spacing may be achieved by an annular shoulder located on the insert to abut the lower surface of the well 2 (ie the upper surface as shown in the drawings in which the well 2 is shown in its inverted position ready for testing of the samples).

Alternatively, and preferably, as shown in FIG. 5 of this application, the channel 8A is stepped in diameter whereby an annular shoulder 80 facing towards the well 4 is provided as a locator for a plug 62.

1. A method of testing a material comprising providing a material to be tested (hereinafter “test material”) across a region of a support member which is arranged to define an opening, said opening being substantially closed by a plug means having a surface in contact with said test material that is substantially coplanar with said region, said test material being adhered to said region of the support member, and moving a force applying means relative to said test material to apply a force to said material through the plug means in a direction away from said region of the support member and wherein the plug means does not substantially deform under the application of said force.

2. A method according to claim 1, which includes recording the force applied to said test material or a parameter relating to the force applied by said force applying means.

3. A method according to claim 1, wherein a multiplicity of values for the force applied to said test material are recorded at different times during the testing of said material.

4. A method according to claim 1, wherein data relating to the force applied is recorded in a database under the control of a computer and said computer also controls the movement of said force applying means relative to said test material.

5. A method according to claim 1, wherein said force applying means applies a force that deforms the test material.

6. A method according to claim 1, which includes moving the force applying means to apply said force to said material.

7. A method according to claim 1, wherein said test material is stationary during application of said force by said force applying means.

8. A method according to claim 1, wherein a z axis of said force applying means which axis defines the direction in which the force applying means moves relative to the test material, is substantially in line with the centre of the region which is arranged to define said opening so that when said force applying means passes through the opening, it passes substantially centrally through the opening.

9. A method according to claim 1, which includes the step of constructing a force versus displacement relationship for the test material.

10. A method according to claim 1, wherein said support member defines a receptacle for containing the test material, said region, which is arranged to define said opening, being located within said receptacle.

11. A method according to claim 1, wherein said test material is preformed and the method includes the steps of selecting a said preformed test material, positioning it across said region of said support member which is arranged to define said opening and causing it to adhere to said region.

12. A method according to claim 1, wherein a precursor of the test material is selected and contacted with said support member, said precursor being in a different physical form compared to said test material, wherein said test material forms on said support member after contact of the precursor therewith.

13. A method according to claim 12, wherein said precursor includes at least first and second components which are involved in the formation of the test material.

14. A method according to claim 13, wherein, in a series of tests, the identity, and/or amounts of the first and second components are varied; and/or the processes to which the first and second components are subjected are varied; and/or the identity and/or amounts of other components are varied, with a view to affecting the properties of the test materials formed.

15. A method of testing a test material comprising providing a selecting a precursor of said test material, contacting said precursor with a support member and forming said test material on the support member across a region of a support member which is arranged to define an opening, said opening being substantially closed by a plug means having a surface in contact with said test material that is substantially coplanar with said region, said test material being adhered to said region of the support member, moving a force applying means relative to said test material to apply a force to said material through the plug means in a direction away from said region of the support member and wherein the plug means does not substantially deform under the application of said force and recording the force applied or a parameter relating to the force applied to said test material by said force applying means.

16. A method of testing a plurality of test materials comprising providing a plurality of test materials across respective regions of said support member which are arranged to define respective openings, each said opening being substantially closed by a respective plug means having a surface in contact with said respective test material that is substantially coplanar with its respective region, said test materials being adhered to their respective regions of the support member and to said surfaces of the respective plug means, and moving a force applying means relative to said test materials to apply a force to said materials through the respective plug means in a direction away from its respective region of the support member and wherein the plug means do not substantially deform under the application of said force.

17. A method according to claim 16, wherein said support member defines an array of said regions, which regions are arranged in parallel rows.

18. A method according to claim 17, wherein the same force applying means issued to apply a respective said force to each of said plurality of test materials in turn.

19. A method according to claim 16, which includes the step of moving said support member to enable said force applying means to apply said force to first and second materials included in said plurality of test materials.

20. A method according to claim 16, wherein the movement of said force applying means relative to each test material is controlled by a computer.

21. A method according to claim 1, wherein said test material adheres to said surface of the plug means.

22. Apparatus for testing a material comprising a support member which has at least one region that is arranged to define an opening and across which a test material may be located in use; said opening being substantially closed, in an initial set up of said apparatus, by a plug means having a surface contactable in use with said test material that is substantially coplanar with said region, said region being capable of being adhered to by a test material, and a force applying means which is movable relative to the support member for applying a force through the plug means to a test material located in said region during use.

23. Apparatus according to claim 22, which includes a computer.

24. Apparatus according to claim 24, wherein said computer includes an output for controlling movement of the force applying means relative to the support member; and an input for receiving data relating to the force applied and the reaction of the test material to the force applied.

25. Apparatus according to claim 22, wherein said computer controls the movement of the support member and said force applying means.

26. Apparatus according to claim 22, said apparatus including first measurement means for measuring the force applied by said force applying means and second measurement means for measuring the distance traveled by said force applying means during a test.

27. Apparatus according to claim 22, wherein said first and second measurement means are arranged to communicate with a computer which includes means for storing information relating to the identity of each test material tested using the apparatus and means for storing measurements taken.

28. Apparatus according to claim 22, wherein said support member comprises an individual sample holder.

29. Apparatus according to claim 22, wherein said support member comprises a well plate which includes an array of receptacles, each of which includes a respective said opening into and/or through which said force applying means is arranged to pass in use.

30. Apparatus according to claim 22, wherein the support member and the plug means are made of the same material.

31. Apparatus according to claim 22, wherein the support member and the plug means are made of copper.

32. Apparatus according to claim 22, wherein said surface of the plug means is capable of being adhered to by a test material.

33. Apparatus according to claim 22, wherein the region of the support member and, the surface of the plug means to which the test material adheres in use of the apparatus are treated to improve adhesion of the test material thereto.

34. Apparatus according to claim 22, wherein the opening is stepped in diameter whereby an annular shoulder is provided as a locator for the plug means.

35. Apparatus according to claim 22, wherein the plug means is a close fit in the opening.

36. Apparatus according to claim 22, wherein the plug means comprising a central member defining the surface to which the test material adheres and an annular member of low friction material surrounding the central member and having an end surface coplanar with the surface of the central member to which the test material adheres.
